(19) United States
(12) Patent Application Publication
(10) Pub. No.: US 2014/0266625 A1
(43) Pub. Date: Sep. 18, 2014

(54) ASSISTED ENERGY EFFICIENT PEER-TO-PEER (P2P) COMMUNICATIONS

(71) Applicant: QUALCOMM Incorporated, San Diego, CA (US)

(72) Inventors: Simone Merlin, San Diego, CA (US); Hemanth Sampath, San Diego, CA (US); Alfred Asterjadhi, San Diego, CA (US)

(73) Assignee: QUALCOMM Incorporated, San Diego, CA (US)

(21) Appl. No.: 14/036,010

(22) Filed: Sep. 25, 2013

Related U.S. Application Data
(60) Provisional application No. 61/785,221, filed on Mar. 14, 2013.

(51) Int. Cl. G06K 7/10

(52) U.S. Cl. CPC G06K 7/10366
USPC 340/10.1

(57) ABSTRACT

The operation of one or more low power/low functionality wireless tags is established in a system, and an external station is then introduced to the system. Communication is established between wireless tags and the external station, wherein the external station directly receives advertised information transmitted from the wireless tags. Various modes of operation include: (1) the external STA is introduced into a system including passive wireless tags, which are associated with a wireless access point (AP); (2) the external STA is introduced into a system including active wireless tags, which are associated with a wireless AP; (3) the external STA is introduced into a system including passive wireless tags, which are not associated with a wireless AP; and (4) the external STA is introduced into a system that includes active wireless tags, which are not associated with a wireless AP.

### CROSS REFERENCES

The present application for patent claims priority benefit of co-pending U.S. Provisional Patent Application No. 61/785,221, entitled “Assisted Energy Efficient Peer-To-Peer (P2P) Communications” by Merlin et al., filed Mar. 14, 2013, assigned to the assignee hereof, and expressly incorporated by reference herein.

### FIELD OF THE DISCLOSURE

The present disclosure relates to the introduction of an external wireless station into a wireless communication system including one or more wireless tags.

### RELATED ART

A wireless tag is herein defined as a small wireless station (STA) that is a low power device (typically battery operated) and has minimum functionalities. Some wireless tags are intended to advertise specific information on demand, such as a position or a temperature. Some other wireless tags are intended to perform an action in response to receiving information, such as opening a door (e.g., using an actuator associated with the wireless tag) or logging the received information. Wireless tags may belong to groups, based on shared characteristics of the wireless tags, such as functionality, vendor or location. Based on the above-described nature of a wireless tag, it is possible to have many wireless tags present in a single room (or other small area).

Wireless tags may be associated with a wireless access point (AP), or not associated with any wireless AP. A wireless tag is usually in a sleeping state, thereby conserving power. A wireless tag may be an active device, wherein the wireless tag periodically wakes up to transmit the advertised information. Alternately, a wireless tag may be a passive device, wherein the wireless tag waits to receive an external request before transmitting the advertised information.

It would be desirable to have methods to enable a new external station (STA) to enter a room or area containing one or more wireless tags, wherein the new external STA is enabled to collect advertised information from the one or more wireless tags and/or trigger actions in the one or more wireless tags, by communicating directly with the wireless tags, thereby minimizing power consumption within the wireless system.

### SUMMARY

Accordingly, the present disclosure provides methods for enabling a new external STA to communicate directly with one or more wireless tags in an established wireless system.

In general, the present disclosure establishing the operation of one or more wireless tags in a wireless communication system, and then, introducing a new external STA to the system. The external STA establishes communication with the one or more wireless tags, wherein the external station directly receives advertised information transmitted by the one or more wireless tags.

In accordance with a first embodiment of the present disclosure (Mode_{—}1), each of the one or more wireless tags is associated with a wireless access point (AP) prior to introducing the external station to the wireless communication system, and each of the wireless tags is a passive device that only transmits advertised information in response to a received request.

In accordance with a first variation of the first embodiment (Mode_{—}1A), the wireless AP transmits a beacon to a passive wireless tag, and the passive wireless tag transmits the advertised information in response to the received beacon. In this embodiment, the advertised information can be included in a PS-poll frame transmitted by the passive wireless tag in response to the received beacon.

In accordance with the first variation of the first embodiment, the external station may transmit a request to the wireless AP, wherein the wireless AP transmits the beacon, at least in part, in response to the request.

In accordance with the first variation of the first embodiment, the wireless AP may transmit a beacon to a passive wireless tag. In response, the passive wireless tag transmits a PS-Poll frame to the wireless AP. The wireless AP transmits an acknowledge signal in response to the PS-Poll frame, wherein the passive wireless tag stays in an awake state in response to the acknowledge signal. The external station transmits a request to the awakened passive wireless tag in response to the acknowledge signal, and the awakened passive wireless tag transmits the advertised information in response to the received request.

In accordance with the first variation of the first embodiment, the wireless AP may transmit a beacon to the passive wireless tags, and in response, one or more of the passive wireless tags may transmit a PS-Poll frame. The external station may then transmit a request to the passive wireless tag in response to the PS-Poll frame, wherein the passive wireless tag transmits the advertised information in response to the received request.

In accordance with a second variation of the first embodiment (Mode_{—}1B), the wireless AP may transmit a delivery traffic indication message (DTIM) that specifies one or more passive wireless tags. The external station transmits a request to the specified one or more passive wireless tags while these tags are in an awake state in response to receiving the DTIM. The one or more specified passive wireless tags then transmit the advertised information to the external station in response to the request. In accordance with one aspect of this embodiment, the wireless AP may generate the DTIM in response to a request received from the external station. In accordance with another aspect of this embodiment, the external station may transmit the request in response to receiving a trigger from the wireless AP.

In accordance with a third variation of the first embodiment (Mode_{—}1C), the wireless AP may maintain a downlink wakeup schedule for the passive wireless tags. The wireless AP transmits the wakeup schedule to the external station, and the external station transmits requests to the passive wireless tags at times identified by the wakeup schedule. The passive wireless tags transmit the advertised information to the external station in response to the received requests.

In accordance with a fourth variation of the first embodiment (Mode_{—}1D), the external station may transmit a first wakeup request to the wireless AP, wherein the first wakeup request specifies a wakeup time. In response, the wireless AP transmits a second wakeup request to one or more passive wireless tags, wherein the second wakeup request specifies the wakeup time. In response, the one or more passive wireless tags wake up at the specified wakeup time. The external station transmits a request to the one or more passive wireless tags at the wakeup time, and in response, the one or more passive wireless tags transmit the advertised information to the external station.

In accordance with a fifth variation of the first embodiment (Mode_{—}1E), the wireless AP maintains a downlink wakeup schedule for one or more passive wireless tags. The external station transmits a request to the one or more passive wireless tags at a time not derived from the wakeup schedule. The wireless AP determines whether the external station receives a response to the transmitted request from the one or more passive wireless tags. If the wireless AP determines that the external station did not receive a response to the transmitted request, then the wireless AP transmits the wakeup schedule to the wireless AP. The external station may then use the wakeup schedule to determine times to transmit future requests to the one or more passive wireless tags.

In accordance with a second embodiment of the present disclosure (Mode_{—}2), each of the one or more wireless tags is associated with a wireless access point (AP) prior to introducing the external station to the wireless communication system, and each of the wireless tags is an active device that periodically wakes up to transmit advertised information.

In accordance with one variation of the second embodiment, each of the one or more active wireless tags transmits the advertised information in response to a beacon periodically transmitted by the wireless AP. In this variation, the external station receives the advertised information transmitted from the one or more active wireless tags in response to the beacon.

In another variation of the second embodiment, each of the one or more wireless tags transmits the advertised information at times negotiated with the wireless AP. The wireless AP shares these negotiated times with the external station. The external station then wakes up at these negotiated times to receive the advertised information transmitted by the one or more active wireless tags.

In accordance with a third embodiment of the present disclosure (Mode_{—}3), the wireless communication system includes one or more passive wireless tags that are not associated with a wireless AP.

In one variation of the third embodiment (Mode_{—}3A), the one or more passive wireless tags wake up to receive requests for advertised information at a first duty cycle. The external station transmits a series of requests in a manner that ensures that at least one of these requests is received by the one or more passive wireless tags in view of the first duty cycle. The passive wireless tags transmit the advertised information in response to the received requests.

In another variation of the third embodiment (Mode_{—}3B), each of the passive wireless devices includes a low-power wakeup circuit. In this embodiment, the external station transmits a wakeup signal, which is received by the low-power wakeup circuits of the passive wireless devices, thereby waking up the passive wireless devices. The external station then transmits a request to the awakened passive wireless devices. The passive wireless devices then transmit the advertised information in response to the received request.

In accordance with a fourth embodiment of the present disclosure (Mode_{—}4), the wireless communication system includes one or more active wireless tags that are not associated with a wireless AP.

In one variation of the fourth embodiment (Mode_{—}4A), each of the one or more active wireless tags wakes up with a second duty cycle to periodically transmit discovery packets including the advertised information. The external station wakes up at a first plurality of times at intervals selected in view of the second duty cycle to ensure that the external station receives at least one of the discovery packets.

In another variation of the fourth embodiment (Mode_{—}4B), each of the one or more active wireless tags includes a low-power wakeup circuit. In this embodiment, the external station transmits a wakeup signal, which is received by the low-power wakeup circuits of the active wireless tags, thereby waking up the active wireless tags. In response, the one or more active wireless tags transmit discovery packets including the advertised information to the external station.

A method for operating in a wireless communications system is described. A communication from a wireless access point may be received by a tag of the one or more wireless tags in a communication system. Advertised information about the tag may be transmitted by the tag directly to a station external to the wireless communication system.

In some embodiments, the communication may be a beacon. The advertised information may transmitted in response to the beacon. The beacon may identify the tag within the beacon.

In one example, a Power Save Poll (PS-Poll) may be transmitted in response to the beacon. In some embodiments, the advertised information may be included in the PS-Poll. In one example, one example, an acknowledge signal may be received from the wireless access point in response to the PS-Poll. An active state may be maintained in response to the acknowledge signal. A probe request from the station may be received during the active state. In one example, transmitting the advertised information includes transmitting the advertised information in a response to the probe request.

In some embodiments, an active state may be maintained following the transmission of the PS-Poll. A probe request may be received from the station during the active state. In one example, transmitting the advertised information includes transmitting the advertised information in a response to the probe request.

In some embodiments, the communication may be a delivery traffic indication map (DTIM) beacon. In some cases, an active state may be maintained in response to the DTIM beacon. A request may be received from the station during the active state. In one example, transmitting the advertised information includes transmitting the advertised information in a response to the request.

In some cases, the communication establishes a wake up schedule with the wireless access point. A request may be received from the station at a time derived from the wake up schedule. In one example, transmitting the advertised information includes transmitting the advertised information in a response to the request.

In some embodiments, the communication may be a wake up request that specifies a wake up time. At the specified wake up time, the wireless tag may switch to an active state. A request may be received from the station during the active state. In one example, transmitting the advertised information includes transmitting the advertised information in a response to the request. In some cases, transmitting the advertised information includes transmitting the advertised information at the specified wake up time.

A wireless tag is also described. The wireless tag includes a processor and memory in electronic communication with the processor. The memory may embody instructions. The instructions may be executable by the processor to: receive a communication from a wireless access point in a wireless communication system. The wireless communication system may include the wireless tag and the wireless access point. The instructions may be executable by the processor to transmit advertised information about the wireless tag directly to a station external to the wireless system.

An apparatus is also described. The apparatus may include means for receiving, at a tag or one or more wireless tags, a communication from a wireless access point in a wireless communication system, and means for transmitting advertised information about the tag directly to a station external to the wireless communication system. The wireless communication system may include the one or more wireless tags and the wireless access point.

An access point is also described. The access point includes a processor and memory in electronic communication with the processor. The memory may embody instructions. The instructions may be executable by the processor to: receive a communication from a station external to the wireless communication system, and transmit a communication to at least one wireless tag of the one or more wireless tags to trigger the at least one wireless tag to directly transmit advertised information about the at least one wireless tag to the station.

In some embodiments, the at least one wireless tag may transmit advertised information only in response to a received request. In some embodiments, the instructions to establish communication comprise instructions executable by the processor to transmit a beacon to the at least one wireless tag in response to receiving the communication from the station. The at least one wireless tag may transmit to the station the advertised information in response to the beacon. In one example, the communication from the wireless access point may be a beacon.

In some cases, the advertised information may be transmitted from the at least one wireless tag by including the advertised information in a Power Save Poll (PS-Poll) that is transmitted by the at least one wireless tag. In some embodiments, the communication from the station may identify the at least one wireless tag and the beacon may identify the at least one wireless tag within the beacon, in response to the communication.

In one embodiment, the instructions may further be executable by the processor to transmit a beacon to the at least one wireless tag. The instructions may also be executable by the processor to receive, after transmitting the beacon, a Power Save Poll (PS-Poll) from the at least one wireless tag. The instructions may further be executable by the processor to transmit an acknowledgment signal in response to the PS-Poll. The station may transmit a request to the identified at least one wireless tag in response to the acknowledge signal. In some embodiments, the at least one wireless tag may transmit the advertised information in response to the request.

The present disclosure will be more fully understood in view of the following description and drawings.

### BRIEF DESCRIPTION OF THE DRAWINGS

FIGS. 1, 2, 3, 4, 5, 6, 7 and 8 are block diagrams illustrating the introduction of an external wireless station (STA) into an established wireless system that includes a wireless access point (AP) and associated passive wireless tags, in accordance with different variations of a first mode of the present disclosure.

FIGS. 9, 10 and 11 are block diagrams illustrating the introduction of an external wireless STA into an established wireless system that includes a wireless AP and associated active wireless tags, in accordance with different variations of a second mode of the present disclosure.

FIGS. 12 and 13 are block diagrams illustrating the introduction of an external STA into a wireless system that includes one or more passive wireless tags without an associated wireless AP, in accordance with different variations of a third mode of the present disclosure.

FIGS. 14 and 15 are block diagrams illustrating the introduction of an external STA into a wireless system that includes one or more active wireless tags without an associated wireless AP, in accordance with different variations of a fourth mode of the present disclosure.

FIG. 16 shows a diagram that illustrates an exemplary AP in accordance with the present disclosure.

FIG. 17 shows a diagram that illustrates an exemplary wireless tag, terminal, or station in accordance with the present disclosure.

FIG. 18 is a flow chart illustrating an example of a method for operating in a wireless communications system.

FIG. 19 is a flow chart illustrating an example of a method for operating in a wireless communication system.

FIG. 20 is a flow chart illustrating an example of a method for operating in a wireless communications system.

FIG. 21 is a flow chart illustrating an example of a method for operating in wireless communication system.

FIG. 22 is a flow chart illustrating an example of a method for becoming introduced into a wireless communication system that includes one or more wireless tags.

### DETAILED DESCRIPTION

In general, the present disclosure provides four operation modes that enable an external wireless station (STA) to enter an area having an established wireless communication system including a one or more wireless tags, and directly receive advertised information from the one or more wireless tags in an energy efficient manner. In the embodiments described herein, the established wireless communication system includes a wireless local area network (WLAN) operating in accordance with the IEEE 802.11 specification. However, it is understood that the present disclosure is also applicable to wireless communication systems operating in accordance with other protocols.

The present disclosure includes four operation modes, which can be summarized as follows. In a first mode (Mode_{—}1), the external STA is introduced into an established wireless communication system including one or more passive wireless tags, which are associated with a corresponding wireless access point (AP). In a second mode (Mode_{—}2), the external STA is introduced into an established wireless communication system including one or more active wireless tags, which are associated with a corresponding wireless AP. In a third mode (Mode_{—}3), the external STA is introduced into an established wireless communication system including one or more passive wireless tags, which are not associated with a wireless AP. In a fourth mode (Mode_{—}4), the external STA is introduced into an established wireless communication system that includes one or more active wireless tags, which are not associated with a wireless AP. The various modes of the present disclosure allow the external STA to interact directly with the wireless tags in an energy efficient manner.

As described in more detail below, in the first mode Mode_{—}1 and the second mode Mode_{—}2, the external STA may interact with the associated wireless AP to either obtain information regarding a transmission schedule for the wireless tags, or impose a transmission schedule on the wireless tags.

### Mode_{—}1

The first mode Mode_{—}1 will now be described in more detail. In Mode_{—}1, one or more passive wireless tags are associated with a wireless AP, wherein these wireless tags passively wait to be contacted by the wireless AP. The passive wireless tags may implement a standard power save mechanism as defined by the IEEE 802.11 specification, wherein the passive wireless tags listen for beacons periodically transmitted by the wireless AP. If a passive wireless tag is paged by a beacon, the passive wireless tag stays awake for a time period after receiving the beacon to send a PS-Poll frame to the wireless AP (requesting that the wireless AP send any buffered information). If the beacon is a delivery traffic indication message (DTIM), then all of the passive wireless tags stay awake after the beacon to wait for data to be broadcast from the wireless AP. Mode_{—}1 of the present disclosure exploits these mechanisms to synchronize the wake up time of the passive wireless tags in the manners described below.

### Mode_{—}1A

One variation of the first mode Mode_{—}1, which is hereinafter referred to as Mode_{—}1A, exploits the traffic indication map (TIM) paging mechanism implemented by a wireless communication system including a wireless AP and one or more associated passive wireless tags. FIG. 1 is a block diagram illustrating the introduction of an external STA 120 into an established wireless communication system 100 that includes wireless AP 105 and associated passive wireless tags 111-112, in accordance with Mode_{—}1A. External STA 120 may or may not be associated with wireless AP 105 in the described embodiments of Mode_{—}1A. Although only two passive wireless tags 111-112 are illustrated in FIG. 1, it is understood that wireless system 100 can include other numbers of passive wireless tags.

In the embodiment illustrated by FIG. 1, external STA 120 transmits a request (REQ) 121 to wireless AP 105, wherein this request indicates which wireless tag(s), or class of wireless tag(s), is of interest to external STA 120. Based on this received request REQ 121, wireless AP 105 pages the passive wireless tags(s) indicated to be of interest, by setting the corresponding bit(s) in a transmitted TIM 122. In the illustrated embodiment, the request signal REQ 121 indicates that passive wireless tag 111 is a wireless tag of interest, and passive wireless tag 112 is not a wireless tag of interest. Thus, the transmitted TIM 122 specifies (pages) passive wireless tag 111, but not passive wireless tag 112.

In response, the passive wireless tag 111 specified by TIM 122 transmits a PS-Poll (or a trigger frame) 123 to wireless AP 105. In addition to information typically included in a conventional PS-Poll/trigger frame, the PS-Poll/trigger frame 123 transmitted by the passive wireless tag 111 is modified to include the information to be advertised (AD_INFO) by passive wireless tag 111 (e.g., temperature, position or another measured parameter). External STA 120 listens for the PS-Poll/trigger frame 123 and the associated AD_INFO transmitted from passive wireless tag 111. As a result, external STA 120 receives the AD_INFO directly from passive wireless tag 111. Note that wireless AP 105 does not respond to the PS-Poll/trigger frame 123 transmitted by the passive wireless TAG 111 in this instance, because wireless AP 105 is aware (from the received request REQ 121) that TIM 122 was transmitted solely for the purpose of retrieving the AD_INFO from the passive wireless tag(s) of interest.

In one variation of the embodiment illustrated by FIG. 1, the request REQ 121 provided by external STA 120 causes wireless AP 105 to transmit a TIM 122 that explicitly triggers a specific class of wireless tags to transmit advertising frames, instead of PS-Poll/trigger frames. In this variation, rather than transmitting PS-Poll/trigger frame 123, passive wireless tag 111 transmits advertising frame 124, which includes the associated AD_INFO. The external STA 120 receives the AD_INFO directly from the advertising frame 124.

FIG. 2 is a block diagram 200 illustrating an alternate embodiment of Mode_{—}1A, wherein passive wireless tag 111 responds to the TIM 122 by transmitting a conventional PS-Poll 125, which does not include the above-described AD_INFO. In response, wireless AP 105 transmits a conventional acknowledge (ACK) message 126, indicating to passive wireless tag 111 that there is ‘more data’ to be transmitted. Hence, the wireless tag(s) indicated by TIM 122 (e.g., passive wireless tag 111) will stay awake, awaiting the transmission of additional data from wireless AP 105. During this time, external STA 120 broadcasts a special probe request 127, which is received by (awakened) passive wireless tag 111 (and any other passive wireless tag(s) specified by TIM 122), wherein the special probe request 127 solicits a response that includes the advertised information (AD_INFO). In response to receiving the probe request 127, passive wireless tag 111 transmits a special probe response 128 that includes the AD_INFO. External STA 120 thereby receives the AD_INFO from the special probe response 128.

FIG. 3 is a block diagram 300 illustrating another embodiment of Mode_{—}1A, wherein passive wireless tag 111 responds to the TIM 122 by transmitting a conventional PS-poll 125, which does not include the above-described AD_INFO. In this embodiment, wireless AP 105 does not respond to (i.e., acknowledge) the PS-poll 125 transmitted by passive wireless tag 111. That is, wireless AP 105 does not transmit the acknowledge message 126. Instead, external STA 120 responds to the PS-poll 125 on behalf of wireless AP 105. More specifically, external STA 120 broadcasts the special probe request 127 described above in connection with FIG. 2. In response, passive wireless tag 111 (and any other passive wireless tag(s) indicated by TIM 122) transmits the special probe response 128 described above in connection with FIG. 2, thereby enabling external STA 120 to directly receive the AD_INFO from passive wireless tag 111.

### Mode_{—}1B

A second variation of the first mode (Mode_{—}1), which is hereinafter referred to as Mode_{—}1B, exploits the delivery traffic indication map (DTIM) paging mechanism implemented by a wireless communication system including a wireless AP and one or more associated passive wireless tags. FIG. 4 is a block diagram illustrating the introduction of an external STA 120 into an established wireless system 400 that includes wireless AP 105 and associated passive wireless 111-112, in accordance with Mode_{—}1B. External STA 120 may or may not be associated with wireless AP 105 in the described embodiments of Mode_{—}1B.

In the embodiment illustrated by FIG. 4, external STA 120 transmits a DTIM request (DTIM_REQ) 129 to wireless AP 105, wherein this request DTIM_REQ 129 instructs wireless AP 105 to wake up all of the associated passive wireless tags 111-112. In response, wireless AP 105 waits until it is time to transmit a DTIM beacon, but wireless AP 105 does not have any information to broadcast to the passive wireless tags 111-112 at the time specified to transmit the DTIM beacon. At this time, wireless AP 105 broadcasts a DTIM beacon 130, which specifies the associated passive wireless tags 111-112. In response to receiving this DTIM beacon 130, the passive wireless tags 111-112 will stay awake in anticipation of receiving broadcast data from wireless AP 105. However, as described above, wireless AP 105 does not actually have data to send to passive wireless tags 111-112 at this time. Thus, wireless AP 105 leaves time for external STA 120 to transmit a broadcast request (BCAST_REQ) 131 to the passive wireless tags 111-112. In one embodiment, wireless AP 105 may transmit an optional trigger signal (TRG) 132 to external STA 120, informing external STA 120 that it is time to transmit the broadcast request 131 (thereby allowing the external STA 120 to remain in a sleep mode until this time). Each of the passive wireless tags 111-112 receives the broadcast request 131, and in response, transmits a corresponding reply (that includes the AD_INFO) at a given time after receiving the broadcast request 131. In one embodiment, passive wireless tags 111 and 112 provide replies 133 and 134, respectively, in a staggered manner to avoid collisions. The replies 133 and 134 can be staggered, for example, by causing each of the passive wireless tags 111-112 to respond at a random time based on the unique identifier (ID) assigned to the passive wireless tag.

### Mode_{—}1C

A third variation of the first mode (Mode_{—}1), which is hereinafter referred to as Mode_{—}1C, exploits more advanced scheduling options, which are currently being discussed as an extension of existing IEEE 802.11 protocols. FIG. 5 is a block diagram illustrating the introduction of an external STA 120 into an established wireless system 500 that includes wireless AP 105 and associated passive wireless tags 111-112, in accordance with Mode_{—}1C. External STA 120 is associated with wireless AP 105 in the described embodiments of Mode_{—}1C.

FIG. 5 illustrates an embodiment of Mode_{—}1C, wherein each of the passive wireless tags 111-112 establishes a wakeup schedule with wireless AP 105, wherein the passive wireless tags 111-112 wake up in accordance with the established wakeup schedule to receive download data from wireless AP 105. The wakeup schedules of the passive wireless tags 111-112 are stored by wireless AP 105, in a wakeup schedule table 106, as illustrated in FIG. 5. In this embodiment, external STA 120 initially associates with wireless AP 105, using, for example, an association process defined by the IEEE 802.11 specification (or an extension thereof). External STA 120 then transmits a schedule request (S_REQ) 135 to wireless AP 105, wherein this schedule request 135 instructs wireless AP 105 to provide details of the wakeup schedule table 106 to external STA 120. For example, external STA 120 may request the portions of the wakeup schedule table 106 associated with passive wireless tags 111 and 112. In response, wireless AP 105 transmits the requested portions of the wakeup schedule table 106 to external STA 120 in the form of a schedule response (S_RES) 136. As a result, external STA 120 is informed of the times that the passive wireless tag(s) of interest will be in an awake state. When the passive wireless tag(s) of interest are in an awake state, external STA 120 transmits an AD_INFO request (AD_INFO_REQ) 137 to the passive wireless tag(s) of interest. In response, the passive wireless tag(s) of interest transmit AD_INFO responses (AD_INFO_RES) that include the desired AD_INFO.

Thus, external STA 120 may transmit the AD_INFO request 137 to passive wireless tag 111 when the passive wireless tag 111 is in an active state, and in response, receive a corresponding AD_INFO response 138 from passive wireless tag 111.

If external STA 120 determines that both of passive wireless tags 111-112 will be in an active state at the same time, then external STA 120 may broadcast the AD_INFO request 137 to passive wireless tags 111 and 112 simultaneously, and in response, receive corresponding AD_INFO responses 138 and 139 from passive wireless tags 111 and 112, respectively. In this case, passive wireless tags 111 and 112 transmit the corresponding responses 138 and 139 in a staggered manner.

### Mode_{—}1D

A fourth variation of the first mode (Mode_{—}1), which is hereinafter referred to as Mode_{—}1D, is similar to Mode_{—}1C, but allows external STA 120 to specify the time that the passive wireless tag(s) of interest are in the awake state. FIG. 6 is a block diagram illustrating the introduction of an external STA 120 into an established wireless system 600 that includes wireless AP 105 and associated passive wireless tags 111-112, in accordance with Mode_{—}1D.

As illustrated by FIG. 6, external STA 120 initially associates with wireless AP 105. Wireless AP 105 maintains a wakeup schedule table 106 in the manner described above in connection with FIG. 5. After associating with wireless AP 105, external STA 120 transmits a wakeup request (W_REQ) 140 to wireless AP 105, wherein this wakeup request 140 specifies one or more passive wireless tag(s) of interest, and also specifies a time when these passive wireless tag(s) of interest should be awakened to communicate with external STA 120. In response, wireless AP 105 transmits a second wakeup request (WU_REQ) 141 to the specified passive wireless tag(s) of interest, wherein this wakeup request 141 specifies the time when these passive wireless tag(s) should be awake. In a particular embodiment, wireless AP 105 sends the wakeup request 141 after broadcasting a DTIM beacon, such that all of the associated passive wireless tags 111-112 receive this wakeup request 141. In another embodiment, wireless AP 105 sends the wakeup request 141 at a moment the passive wireless tag(s) of interest are awake based on the contents of wakeup schedule table 106. In response to the received wakeup request 141, the passive wireless tag(s) of interest subsequently wake up at the time specified by the wakeup request 141.

In one embodiment, external STA 120 transmits an AD_INFO request (AD_INFO_REQ) 142 to the passive wireless tag(s) of interest at the specified wakeup time. In response, the passive wireless tag(s) of interest transmit AD_INFO responses (AD_INFO_RES) that include the desired AD_INFO.

Thus, external STA 120 may transmit the AD_INFO request 142 to passive wireless tag 111 at the specified wakeup time, and in response, receive a corresponding AD_INFO response 143 from passive wireless tag 111.

If external STA 120 specifies that both of passive wireless tags 111-112 should be in an active state at the specified wakeup time, then external STA 120 may broadcast the AD_INFO request 142 to passive wireless tags 111 and 112 simultaneously, and in response, receive corresponding AD_INFO responses 143 and 144 from passive wireless tags 111 and 112, respectively. In this case, passive wireless tags 111 and 112 stagger the transmission of the corresponding AD_INFO responses 143 and 144 in the manner described above.

In accordance with an alternate embodiment, the passive wireless tag(s) of interest simply wakeup and transmit the AD_INFO response(s) to external STA 120 at the specified wakeup time. This embodiment eliminates the need for the external STA 120 to transmit the AD_INFO request (AD_INFO_REQ) 144 in the manner described above.

### Mode_{—}1E

A fifth variation of the first mode (Mode_{—}1), which is hereinafter referred to as Mode_{—}1E, is similar to Mode_{—}1C, but does not necessarily require wireless AP 105 to transmit the wakeup schedule table 106 to external STA 120. FIG. 7 is a block diagram illustrating the introduction of an external STA 120 into an established wireless system 700 that includes wireless AP 105 and associated passive wireless tags 111-112, in accordance with Mode_{—}1E.

As illustrated by FIG. 7, external STA 120 initially associates with wireless AP 105. Wireless AP 105 maintains a wakeup schedule table 106 in the manner described above in connection with FIG. 5, wherein wakeup schedule table 106 keeps track of the times that passive wireless tags 111-112 wake up to receive downlink data or trigger frames from wireless AP 105. After associating with wireless AP 105, external STA 120 transmits an AD_INFO request (AD_INFO_REQ) 146 that is addressed to the passive wireless tag(s) of interest at an indeterminate (random) time. At this time, external STA 120 has not yet received any information from the wakeup schedule table 106. Any of the passive wireless tag(s) of interest that happen to be awake at the time that external STA 120 transmits the AD_INFO request 146 will respond to this AD_INFO request 146 with an AD_INFO response (e.g., AD_INFO_RES 147 or AD_INFO_RES 148) that includes the AD_INFO of the passive wireless tag. Staggered transmissions can be used to avoid collisions between multiple passive wireless tags.

Wireless AP 105 also receives the AD_INFO request 146 transmitted by external STA 120, and in response, monitors the wireless medium for AD_INFO responses transmitted by the passive wireless tag(s) of interest. If wireless AP 105 determines that none of the passive wireless tag(s) of interest has sent an AD_INFO response within a predetermined time period, then wireless AP 105 retrieves expected wakeup time schedules (S_INFO) 145 for the tag(s) of interest from wakeup schedule table 106, and transmits these wakeup time schedules 145 to external STA 120. In response, external STA 120 re-transmits the AD_INFO request 146 at a time determined in response to the received wakeup time schedules 145. For example, external STA 120 may re-transmit the AD_INFO request 146 at an earliest determined wakeup time or a best expected wakeup time determined from the received wakeup time schedules 145.

### Mode_{—}1F

A sixth variation of the first mode (Mode_{—}1), which is hereinafter referred to as Mode_{—}1F, is implemented within the Generic Advertisement Service (GAS) framework of the IEEE 802.11 specification. FIG. 8 is a block diagram illustrating the introduction of an external STA 120 into an established wireless system 800 that includes wireless AP 105 and associated passive wireless tags 111-112, in accordance with Mode_{—}1F.

As illustrated by FIG. 8, external STA 120 initially associates with wireless AP 105. Wireless AP 105 maintains a wakeup schedule table 106 in the manner described above in connection with FIG. 5, wherein wakeup schedule table 106 keeps track of the times that passive wireless tags 111-112 wake up to receive downlink data or trigger frames from wireless AP 105. In this embodiment, external STA 120 transmits a GAS initial request (GAS_INIT_REQ) 150 addressed to a specific passive tag or group of passive tags. In the illustrated example, the GAS initial request 150 is addressed to passive tags 111 and 112. Wireless AP 105 receives the GAS initial request 150, and in response, accesses the wakeup schedule table 106 to generate a GAS initial response (GAS_INIT_RES) 151, which includes a passive tag identifier (ID) of each the addressed passive tags, and corresponding next wakeup instants (or earliest wakeup times) for the addressed passive tags. In the illustrated example, the GAS initial response 151 includes passive tag IDs for passive tags 111 and 112, and the next wakeup instants (or earliest wakeup times) for passive tags 111 and 112.

External STA 120 receives the GAS initial response 151, and in response, generates a first GAS comeback request (GAS_CB_REQ) 152 addressed to the passive tag ID of passive tag 111, not earlier than the next specified wakeup time of the passive tag 111. In response, the addressed passive tag 111 replies with one (or multiple) GAS comeback responses (GAS_CB_RES) 153, which include the requested AD_INFO. Similarly, external STA 120 generates a second GAS comeback request 154 addressed to the passive tag ID of passive tag 112, not earlier than the next specified wakeup time of the passive tag 112. In response, the addressed passive tag 112 replies with one (or multiple) GAS comeback responses 155, which include the requested AD_INFO.

In a particular embodiment, if there is a requirement that external STA 120 must be associated with wireless AP 105 before external STA 120 is allowed to query for information from the passive tags 111-112, an addressed passive tag (e.g., passive tag 111) may send a query request (Q_REQ) 156 to wireless AP 105 in response to receiving a GAS comeback request 152 from external STA 120. In this case, the addressed passive tag 111 will wait for a query reply (Q_REP) 157 from wireless AP 105 (which indicates that external STA 120 is associated with wireless AP 105) prior to sending the corresponding GAS comeback response 153 to external STA 120.

### Mode_{—}2

The second mode Mode_{—}2 will now be described in more detail. In Mode_{—}2, active wireless tags are associated with a wireless AP, and these active wireless tags transmit advertisement frames periodically.

### Mode_{—}2A

In a first variation of the second mode Mode_{—}2, which is hereinafter referred to as Mode_{—}2A, each of the active wireless tags transmits a corresponding advertisement frame after each beacon transmitted by the wireless AP.

FIG. 9 is a block diagram illustrating the introduction of an external STA 120 into an established wireless communication system 900 that includes wireless AP 105 and associated active wireless tag 211, in accordance with Mode_{—}2A. External STA 120 may or may not be associated with wireless AP 105 in the described embodiments of Mode_{—}2A. Although only one active wireless tag 211 is illustrated in FIG. 9, it is understood that wireless communication system 200 can include other numbers of active wireless tags. In the embodiment of FIG. 9, wireless AP 105 periodically transmits beacon signals 160 (e.g., in accordance with the IEEE 802.11 specification). After each transmitted beacon signal 160, active wireless tag 211 transmits an advertisement frame (AD_FRAME) 161, which includes the advertised information (AD_INFO) associated with the active tag 211. External STA 120 simply listens for advertisement frame 161 for a time period after each beacon signal 160. In this embodiment, external STA 120 may initially become aware of the times the beacons 160 are transmitted by associating with the wireless AP 105, or by listening for as long as necessary to determine the schedule at which wireless AP 105 transmits beacon signals 160.

### Mode_{—}2B

In a second variation of the second mode (Mode_{—}2), which is hereinafter referred to as Mode_{—}2B, each of the active wireless tags transmits a corresponding advertisement frame after each of ‘X’ beacons transmitted by the wireless AP, wherein ‘X’ is an integer greater than one. For example, each of the active wireless tags may transmit a corresponding advertisement frame after each delivery traffic indication message (DTIM) transmitted by the wireless AP.

FIG. 10 is a block diagram illustrating the introduction of an external STA 120 into an established wireless communication system 1000 that includes wireless AP 105 and associated active wireless tag 211, in accordance with Mode_{—}2B. External STA 120 may or may not be associated with wireless AP 105 in the described embodiments of Mode_{—}2B. Although only one active wireless tag 211 is illustrated in FIG. 10, it is understood that wireless communication system 200 can include other numbers of active wireless tags. In the embodiment of FIG. 10, wireless AP 105 periodically transmits DTIMs 162 (e.g., in accordance with the IEEE 802.11 specification). After each transmitted DTIM 162, active wireless tag 211 transmits an advertisement frame (AD_FRAME) 161, which includes the advertised information (AD_INFO) associated with the active wireless tag 211. External STA 120 simply listens for advertisement frame 161 for a time period after each DTIM 162. In this embodiment, external STA 120 may initially become aware of the times the DTIMs 162 are transmitted by associating with the wireless AP 105, or by listening for as long as necessary to determine the schedule at which wireless AP 105 transmits DTIMs 162.

### Mode_{—}2C

In a third variation of the second mode (Mode_{—}2), which is hereinafter referred to as Mode_{—}2C, each of the active wireless tags transmits a corresponding advertisement frame at a specific time as agreed to with the wireless AP through a negotiated schedule.

FIG. 11 is a block diagram illustrating the introduction of an external STA 120 into an established wireless communication system 1100 that includes wireless AP 105 and associated active wireless tag 211, in accordance with Mode_{—}2C. Wireless AP 105 and active tag 211 initially negotiate a schedule 206, which specifies particular times that the active tag 211 will transmit advertisement frames (including the advertised information (AD_INFO)) to wireless AP 105. Wireless AP 105 stores this schedule 206 in an internal memory.

External STA 120 initially associates with wireless AP 105, using, for example, an association process defined by the IEEE 802.11 specification (or an extension thereof). External STA 120 then transmits a schedule request (S_REQ) 165 to wireless AP 105, wherein this schedule request 165 instructs wireless AP 105 to provide the schedule 206 to external STA 120. In response, wireless AP 105 transmits the schedule 206 to external STA 120 in the form of a schedule response (S_RES) 166. As a result, external STA 120 is informed of the times the active wireless tag 211 (and any other associated active wireless tag(s)) will be transmitting an advertisement frame 167 (which includes the advertised information AD_INFO). External STA 120 then simply wakes up at the times specified by the negotiated schedule 206 and listens to receive the advertisement frames 167 from the active tag 211 (and/or any other active tag(s) of interest as specified by the schedule 206).

### Mode_{—}3

The third mode (Mode_{—}3) will now be described in more detail. In Mode_{—}3, passive wireless tags of a system are not associated with a wireless AP.

### Mode_{—}3A

In a first variation of the third mode (Mode_{—}3), which is hereinafter referred to as Mode_{—}3A, one or more passive wireless tags are awake with a known duty cycle.

FIG. 12 is a block diagram illustrating the introduction of an external STA 120 into a wireless communication system 1200 that includes one or more passive wireless tags (including, passive wireless tag 111). Passive tag 111 periodically wakes up with a predetermined duty cycle D1 to receive advertising information requests from other wireless devices, such as external STA 120. External STA 120 is aware of the duty cycle D1 of the passive wireless tag 111 (e.g., through a corresponding specification or standard), and in response, transmits a series of advertising information requests (AD_INFO requests) 171 in a manner that ensures that at least one of these AD_INFO requests 171 is received by passive wireless tag 111 (in view of the known duty cycle D1). Upon receiving one of the AD_INFO requests 171, passive tag 111 transmits an advertisement frame 172 (including the requested AD_INFO) to external STA 120.

### Mode_{—}3B

In a second variation of the third mode (Mode_{—}3), which is hereinafter referred to as Mode_{—}3B, one or more passive wireless tags are provisioned with a low power wake up circuit.

FIG. 13 is a block diagram illustrating the introduction of an external STA 120 into a wireless communication system 1300 that includes one or more passive wireless tags (including passive wireless tag 111), each of which includes a low power wakeup circuit. As illustrated by FIG. 13, passive wireless tag 111 includes low-power wake up circuit 175. External STA 120 initially transmits a low power wakeup signal 176. Upon receiving this low power wakeup signal 176, the low power wake up circuit 175 causes passive tag 111 to transition from a sleep mode to an awake mode. Note that other passive wireless tags in system 1300 having low power wake up circuits will also transition from a sleep mode to an awake mode at this time. External STA 120 then transmits an AD_INFO request frame (AD_INFO_REQ) 177, which is received by the awakened passive tag 111 (as well as any other passive tags awakened by wakeup signal 176). In response, passive tag 111 transmits an advertisement frame 178 (including the requested AD_INFO) to external STA 120 with a random delay (to avoid collisions with other advertisement frames transmitted by other passive tags in response to the same AD_INFO_REQ frame 177).

### Mode_{—}4

The fourth mode (Mode_{—}4) will now be described in more detail. In Mode_{—}4, active wireless tags of a system are not associated with a wireless AP.

### Mode_{—}4A

In a first variation of the fourth mode (Mode_{—}4), which is hereinafter referred to as Mode_{—}4A, one or more active wireless tags transmit discovery packets (including the advertised information, AD_INFO) with a known duty cycle.

FIG. 14 is a block diagram illustrating the introduction of an external STA 120 into a wireless communication system 1400 that includes one or more active wireless tags (including active wireless tag 211), that awaken with a known duty cycle D2 to transmit a series of discovery packets 180 that include the corresponding AD_INFO. External STA 120 is aware of the duty cycle D2 of the active wireless tags of system 1400 (e.g., through a corresponding specification or standard), and wakes up at intervals selected to ensure that at least one of discovery packets 180 transmitted by active tag 211 is received (in view of the known duty cycle D2). Upon receiving one of the discovery packets 180, external STA 120 is able to determine when future discovery packets 180 will be transmitted by active wireless tag 211. Using this information, external STA 120 is able to wake up to receive future discovery packets 180 transmitted by active wireless tag 211 (or otherwise directly communicate with active wireless tag 211).

### Mode_{—}4B

In a second variation of the fourth mode (Mode_{—}4), which in hereinafter referred to as Mode_{—}4B, one or more active wireless tags are provisioned with a low power wakeup circuit.

FIG. 15 is a block diagram illustrating the introduction of an external STA 120 into a wireless communication system 1500 that includes one or more active wireless tags (including active wireless tag 211), each of which includes a low power wakeup circuit. As illustrated by FIG. 15, active tag 211 includes low-power wake up circuit 185. External STA 120 initially transmits a low power wakeup signal 186. Upon receiving this low power wakeup signal 186, the low power wake up circuit 185 causes active tag 211 to transition from a sleep mode to an awake mode. Note that other active tags having low power wake up circuits will also transition from a sleep mode to an awake mode at this time. Each of the awakened active tags transmits a discovery packet (including the associated AD_INFO) after a random time period, thereby avoiding collisions. For example, active tag 211 transmits discovery packet 187 (including the associated AD_INFO) with a random delay in response to receiving the wakeup signal 186. External STA 120 receives each of the transmitted discovery packets, including the discovery packet 187 transmitted by active tag 211. Upon receiving the discovery packet 187, external STA 120 is able to determine when future discovery packets 187 will be transmitted by active wireless tag 211. Using this information, external STA 120 is able to wake up to receive future discovery packets 187 transmitted by active wireless tag 211 (or otherwise directly communicate with active wireless tag 211).

FIG. 16 shows a diagram 1600 that illustrates one example of an AP 105-a in accordance with the present disclosure. In some embodiments, the AP 105-a may be an example of the APs 105 of FIGS. 1, 2, 3, 4, 5, 6, 7, 8, 9, 10, and/or 11. The AP 105-a may be configured to implement at least some of the features and functions described above with respect to FIGS. 1, 2, 3, 4, 5, 6, 7, 8, 9, 10, and/or 11. The AP 105-a may include a processor 1610, a memory 1620, transceivers 1640, and antennas 1650. The AP 105-a may also include a communications manager 1630 and a communications establishment module. Each of these components may be in communication with each other, directly or indirectly, over one or more buses 1615.

The memory 1620 may include RAM and ROM. The memory 1620 may also store computer-readable, computer-executable software (SW) code 1625 containing instructions that are configured to, when executed, cause the processor 1610 to perform various functions described herein for introducing an external wireless station into a wireless communication system. Alternatively, the software code 1625 may not be directly executable by the processor 1610 but be configured to cause the computer, e.g., when compiled and executed, to perform functions described herein.

The processor 1610 may include an intelligent hardware device, e.g., a CPU, a microcontroller, an ASIC, etc. The processor 1610 may process information received through the transceivers 1640, and/or the communications manager 1630. The processor 1610 may also process information to be sent to the transceivers 1640 for transmission through the antennas 1650, to the communications manager 1630. The processor 1610 may handle, alone or in connection with another component of the AP 105-a, various aspects of transmitting beacon signals, and establishing communication between a station external to the wireless system and at least one wireless tag. In some embodiments, the processor 1610 may implement one or more aspects of the communications establishment module 1635.

The transceivers 1640 may include a modem configured to modulate the packets and provide the modulated packets to the antennas 1650 for transmission, and to demodulate packets received from the antennas 1650. The transceivers 1640 may be implemented as one or more transmitters 1642 and one or more separate receivers 1644. The transceivers 1640 may be configured to communicate bi-directionally, via the antennas 1650, with one or more associated stations and/or tags 111. The AP 105-a may include multiple antennas 1650. The AP 105-a may communicate with one or more tags (e.g., passive tags 111, 112, active tags 211, external STAs 120, etc.) using the, the transceivers 1640.

According to the architecture of FIG. 16, the AP 105-a may further include a communications management module 1630 and a communications establishment module 1635. The communications management module 1630 may establish and manage communications between the AP 105-a and one or more tags. In some cases, the communications management module 1620 may associate and manage associations with one or more tags (e.g., passive tags 111, 112, active tags 211, external STAs 120). The communications establishment module 1635 may facilitate the establishment of communications between one or more tags. For example, the communications establishment module 1635 may facilitate the establishment of communications between an external STA 120 and an associated tag (e.g., passive tag 111, 112, active tag 211) as described with respect to FIGS. 1, 2, 3, 4, 5, 6, 7, 8, 9, 10, and/or 11. The communications management module 1630 and/or the communications establishment module 1635 may be in communication with some or all of the other components of the AP 105-a via the bus or buses 1615. Alternatively, functionality of the communications manager 1630 may be implemented as a component of the transceivers 1640, as a computer program product, and/or as one or more controller elements of the processor 1610.

FIG. 17 shows a diagram 1700 that illustrates an example of a tag 1705 in accordance with the present disclosure. Tag 1705 may be an example of passive tag 111 as described in FIGS. 1, 2, 3, 4, 5, 6, 7, 8, 12, and/or 13, passive tag 112 as described in FIGS. 1, 2, 3, 4, 5, 6, 7, and/or 8, active tag 211 as described in FIGS. 9, 10, 11, 14, and/or 15, and/or external STA 120 as described in FIGS. 1, 2, 3, 4, 5, 6, 7, 8, 9, 10, 11, 12, 13, 14, and/or 15. In one example, the tag 1705 (e.g., passive tag 111, 112, active tag 211, and/or external STA 120) may be part of the wireless communication system. In another example, the tag 1705 may be being introduced into the wireless communications system. The tag 1705 may have various other configurations and may be included or be part of a personal computer (e.g., laptop computer, netbook computer, tablet computer, etc.), a cellular telephone, a PDA, a digital video recorder (DVR), an internet appliance, a gaming console, an e-readers, etc. The tag 1705 may have an internal power supply (not shown), such as a small battery, to facilitate mobile operation. The tag 1705 may be configured to implement at least some of the features and functions described above with respect to FIGS. 1-15.

The tag 1705 may include a processor 1710, a memory 1720, transceivers 1740, antennas 1750, a state module 1760, a communications management module 1730, and a discovery module 1735. Each of these components may be in communication with each other, directly or indirectly, over one or more buses 1715.

The memory 1720 may include random access memory (RAM) and read-only memory (ROM). The memory 1720 may store computer-readable, computer-executable software (SW) code 1725 containing instructions that are configured to, when executed, cause the processor 1710 to perform various functions described herein. Alternatively, the software code 1725 may not be directly executable by the processor 1710 but be configured to cause the computer (e.g., when compiled and executed) to perform functions described herein.

The processor 1710 may include an intelligent hardware device, e.g., a central processing unit (CPU), a microcontroller, an ASIC, etc. The processor 1710 may process information received through the transceivers 640. The processor 1710 may process information to be sent to the transceivers 1740 for transmission through the antennas 1750. The processor 1710 may handle, alone or in connection with the communications management module 1730 and/or the discover module 1735, various aspects of introducing a station 210 into a wireless communications system.

The transceivers 1740 may be configured to communicate bi-directionally with access points (e.g., wires access points 105) and/or other tags (e.g., passive tags 111, 112, active tags 211, external STAs 120). The transceivers 1740 may be implemented as one or more transmitters 1742 and one or more separate receivers 1744. The transceivers 1740 may support communications with a WLAN or Wi-Fi network. The transceivers 1740 may include a modem configured to modulate the packets and provide the modulated packets to the antennas 1750 for transmission, and to demodulate packets received from the antennas 1750.

According to the architecture of FIG. 17, the tag 1705 may further include the communications management module 1730 and the discovery module 1735, and the state module 1760. The communications management module 1730 may establish and manage communications between the tag 1705 and other tags and/or between the tag 1705 and an AP (e.g., AP 105). In one example, the communications management module 1730 may associate the tag 1705 with an AP. The discovery module 1735 may enable the tag 1705 to discover advertised information about other tags and/or may enable the tag 1705 to be discovered (e.g., provide advertised information about the tag 1705) to other tags. For example, the discovery module 1735 may enable the tag 1705 to be introduced into a wireless communication system and/or be discovered by a tag that is external to the wireless communication system according to the different modes (e.g., Mode_{—}1, Mode_{—}2, Mode_{—}3, and/or Mode_{—}4) and variations of modes as described in FIGS. 1-15. The discovery module 1735 may be a component of the tag 1705 in communication with some or all of the other components of the tag 1705 over the one or more buses 1715. Alternatively, functionality of the discovery module 1735 may be implemented as a component of the transceivers 1740, as a computer program product, and/or as one or more controller elements of the processor 1710.

The state module 1760 may reflect and control the current device state (e.g., active state, sleep state). As described herein, the state module 1760 may switch between states to conserve power. In some cases, the state module 1760 may switch between states based on a schedule and/or based on signals or messages received via the transceiver 1740.

FIG. 18 is a flow chart illustrating an example of a method 1800 for operating in a wireless communications system. In one configuration, the method 1800 may be implemented by an AP such as AP 105 illustrated in FIGS. 1, 2, 3, 4, 5, 6, 7, 8, 9, 10, 11, and/or 16. In particular, the method 1800 may be implemented by the communications establishment module 1635 of FIG. 16.

At block 1805, a communication may be received from a station external to the wireless communication system. In one example, the station may be attempting to join the wireless communications system. For example, the station may be using the wireless access point to facilitate the introduction of the station into the wireless communications system (a system of one or more tags, for example).

At block 1810, communication may be established between at least one of the one or more wireless tags and the station. For example, communication may be established using any of the modes (e.g., Mode_{—}1, Mode_{—}2, Mode_{—}3, Mode_{—}4) including variations of the modes as described herein with respect to FIGS. 1, 2, 3, 4, 5, 6, 7, 8, 9, 10, 11, 12, 13, 14, and/or 15.

Thus, the method 1800 may facilitate the introduction of a station that is external to the wireless communication system to one or more tags within the communications system. It should be noted that the method 1800 is just one implementation and that the operations of the method 1800 may be rearranged or otherwise modified such that other implementations are possible.

FIG. 19 is a flow chart illustrating an example of a method 1900 for operating in a wireless communication system. In one configuration, the method 1900 may be implemented by an AP such as AP 105 illustrated in FIGS. 1, 2, 3, 4, 5, 6, 7, 8, 9, 10, 11, and/or 16. In particular, the method 1900 may be implemented by the communications establishment module 1635 of FIG. 16.

At block 1905, each of the one or more wireless tags may be associated with the wireless access point prior to the establishing communication between the station and the at least one tag.

At block 1910, a communication may be received from a station external to the wireless communication system.

At block 1915, communication may be established between at least one of the one or more wireless tags and the station.

At block 1920, the at least one wireless tag may transmit the advertised information only in response to a received request.

Thus, the method 1900 may facilitate the introduction of a station that is external to the wireless communication system to one or more tags within the communications system. It should be noted that the method 1900 is just one implementation and that the operations of the method 1900 may be rearranged or otherwise modified such that other implementations are possible.

FIG. 20 is a flow chart illustrating an example of a method 2000 for operating in a wireless communications system. In one configuration, the method 2000 may be implemented by a tag such as passive tag 111 and/or active tag 211 as illustrated in FIGS. 1, 2, 3, 4, 5, 6, 7, 8, 9, 10, 11, 12, 13, 14, 15, and/or 17. In particular, the method 2000 may be implemented by the discovery module 1735 of FIG. 17.

At block 2005, a communication may be received from a wireless access point. Examples of communications include a beacon, a traffic indication map (TIP), a delivery traffic indication message (DTIM), association message, wake-up unit request, advertised information request, etc.

At block 2010, advertised information about the tag may be transmitted directly to a station. For example, advertised information about the tag may be transmitted directly to the station using any of the modes (e.g., Mode_{—}1, Mode_{—}2, Mode_{—}3, Mode_{—}4) including variations of the modes as described herein with respect to FIGS. 1, 2, 3, 4, 5, 6, 7, 8, 9, 10, 11, 12, 13, 14, and/or 15.

Thus, the method 2000 may allow an external station (e.g., STA 120) to be introduced into an established wireless communications system. It should be noted that the method 2000 is just one implementation and that the operations of the method 2000 may be rearranged or otherwise modified such that other implementations are possible.

FIG. 21 is a flow chart illustrating an example of a method 2100 for operating in wireless communication system. In one configuration, the method 2100 may be implemented by a tag such as passive tag 111 and/or active tag 211 as illustrated in FIGS. 1, 2, 3, 4, 5, 6, 7, 8, 9, 10, 11, 12, 13, 14, 15, and/or 17. In particular, the method 2000 may be implemented by the discovery module 1735 of FIG. 17.

At block 2105, a communication may be received from a wireless access point.

At block 2110, an active state may be maintained following the receipt of the communication.

At block 2115, a request from a station external to the wireless communication system may be received during the active state.

At block 2120, advertised information about the tag may be transmitted directly to the station in response to the request.

Thus, the method 2100 may allow an external station (e.g., STA 120) to be introduced into an established wireless communications system. It should be noted that the method 2100 is just one implementation and that the operations of the method 2100 may be rearranged or otherwise modified such that other implementations are possible.

FIG. 22 is a flow chart illustrating an example of a method 2200 for becoming introduced into a wireless communication system that includes one or more wireless tags. In one configuration, the method 2200 may be implemented by a tag such as external STA 120 as illustrated in FIGS. 1, 2, 3, 4, 5, 6, 7, 8, 9, 10, 11, 12, 13, 14, 15, and/or 17. In particular, the method 2200 may be implemented by the discovery module 1735 of FIG. 17.

At block 2205, a station external to the wireless communications system may transmit a communication to a wireless access point. The station may or may not be associated with the wireless access point.

At block 2110, the station may receive information about at least one wireless tag directly from the at least one wireless tag. The station may receive the advertised information in response to a beacon from the wireless access point.

Thus, the methods 1800, 1900, 2000, 2100, and 2200 may provide operations for wireless communication. In some instances, the operations of two or more of the methods 1800, 1900, 2000, 2100, and 2200 may be combined to produce other implementations.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

We claim:

1. A method for operating in a wireless communication system, the system including one or more wireless tags, the method comprising:
receiving, by a tag of the one or more wireless tags, a communication from a wireless access point; and
transmitting, by the tag, advertised information about the tag directly to a station external to the wireless communication system.

2. The method of claim 1, wherein the communication comprises a beacon, and wherein the advertised information is transmitted in response to the beacon.

3. The method of claim 2, wherein the beacon identifies the tag within the beacon.

4. The method of claim 2, further comprising:
transmitting a Power Save Poll (PS-Poll) in response to the beacon.

5. The method of claim 4, wherein transmitting the advertised information comprises including the advertised information in the PS-Poll.

6. The method of claim 4, further comprising:
receiving from the wireless access point an acknowledge signal in response to the PS-Poll;
maintaining an active state in response to the acknowledge signal; and
receiving, during the active state, a probe request from the station,
wherein transmitting the advertised information comprises transmitting the advertised information in a response to the probe request.

7. The method of claim 4, further comprising:
maintaining an active state following the transmission of the PS-Poll; and
receiving, during the active state, a probe request from the station,
wherein transmitting the advertised information comprises transmitting the advertised information in a response to the probe request.

8. The method of claim 1, wherein the communication comprises a delivery traffic indication map (DTIM) beacon.

9. The method of claim 8, further comprising:
maintaining an active state in response to the DTIM beacon; and
receiving, during the active state, a request from the station,
wherein transmitting the advertised information comprises transmitting the advertised information in a response to the request.

10. The method of claim 1, wherein the communication establishes a wake up schedule with the wireless access point.

11. The method of claim 10, further comprising:
receiving a request from the station at a time derived from the wake up schedule,
wherein transmitting the advertised information comprises transmitting the advertised information in a response to the request.

12. The method of claim 1, wherein the communication comprises a wake up request that specifies a wake up time.

13. The method of claim 12, further comprising:
switching to an active state at the specified wake up time; and
receiving, during the active state, a request from the station,
wherein transmitting the advertised information comprises transmitting the advertised information in a response to the request.

14. The method of claim 12, wherein transmitting the advertised information comprises transmitting the advertised information at the specified wake up time.

15. A wireless tag, comprising:
a processor; and
a memory in electronic communication with the processor, the memory embodying instructions, the instructions being executable by the processor to:
receive a communication from a wireless access point in a wireless communication system, the wireless communication system comprising the wireless tag and the wireless access point; and
transmit advertised information about the wireless tag directly to a station external to the wireless communication system.

16. The device of claim 15, wherein the communication comprises a beacon, and wherein the advertised information is transmitted in response to the beacon.

17. The device of claim 16, wherein the beacon identifies the wireless tag within the beacon.

18. The device of claim 16, wherein the instructions are executable by the processor to:
transmit a Power Save Poll (PS-Poll) in response to the beacon.

19. The device of claim 18, wherein the instructions executable to transmit the advertised information comprise instructions executable by the processor to include the advertised information in the PS-Poll.

20. An apparatus, comprising:
means for receiving, at a tag of one or more wireless tags, a communication from a wireless access point in a wireless communication system, the wireless communication system comprising the one or more wireless tags and the wireless access point; and
means for transmitting, from the tag, advertised information about the tag directly to a station external to the wireless communication system.

21. The apparatus of claim 20, wherein the communication comprises a beacon, and wherein the advertised information is transmitted in response to the beacon.

22. The apparatus of claim 21, wherein the beacon identifies the tag within the beacon.

23. The apparatus of claim 21, further comprising:
means for transmitting a Power Save Poll (PS-Poll) in response to the beacon.

24. The apparatus of claim 23, wherein the means for transmitting the advertised information comprise means for including the advertised information in the PS-Poll.

25. An access point, comprising:
a processor; and
a memory in electronic communication with the processor, the memory embodying instructions, the instructions being executable by the processor to:
receive a communication from a station external to a wireless communication system, the wireless communication system comprising one or more wireless tags and the access point; and
transmit a communication to at least one wireless tag of the one or more wireless tags to trigger the at least one wireless tag to directly transmit advertised information about the at least one wireless tag to the station.

26. The access point of claim 25, wherein the at least one wireless tag transmits the advertised information only in response to a received request.

27. The access point of claim 26, wherein the communication to the at least one wireless tag comprises a beacon, and wherein the at least one wireless tag transmits the advertised information in response to the beacon.

28. The access point of claim 27, wherein the advertised information from the at least one wireless tag is included in a Power Save Poll (PS-Poll) transmitted by the at least one wireless tag.

29. The access point of claim 27, wherein:
the communication from the station identifies the at least one wireless tag; and
the beacon, in response to the communication from the station, identifies the at least one wireless tag within the beacon.

30. The access point of claim 26, wherein the instructions are executable by the processor to:
transmit a beacon to the at least one wireless tag;
after transmitting the beacon, receive a Power Save Poll (PS-Poll) from the at least one wireless tag;
transmit an acknowledge signal in response to the PS-Poll, wherein the station transmits a request to the at least one wireless tag in response to the acknowledge signal, and wherein the at least one wireless tag transmits the advertised information in response to the request.

31. An apparatus, comprising:
means for receiving a communication from a station external to a wireless communication system, the wireless communication system comprising one or more wireless tags and the access point; and
means for transmitting a communication to at least one wireless tag of the one or more wireless tags to trigger the at least one wireless tag to directly transmit advertised information about the at least one wireless tag to the station.

32. The apparatus of claim 31, wherein the at least one wireless tag transmits the advertised information only in response to a received request.

33. The apparatus of claim 32, wherein the communication to the at least one wireless tag comprises a beacon, and wherein the at least one wireless tag transmits the advertised information in response to the beacon.

34. The apparatus of claim 33, wherein the advertised information from the at least one wireless tag is included in a Power Save Poll (PS-Poll) transmitted by the at least one wireless tag.

35. The apparatus of claim 33, wherein:
the communication from the station identifies the at least one wireless tag; and
the beacon, in response to the communication from the station, identifies the at least one wireless tag within the beacon.
